(19) United States
(12) Patent Application Publication
(10) Pub. No.: US 2008/0126483 A1
(43) Pub. Date: May 29, 2008

(54) Method for Contesting at Least Two Interactive Systems Against Each Other and an Interactive System Competition Arrangement

(75) Inventor: Eric Thelen, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,601

(22) PCT Filed: Jul. 21, 2005
(86) PCT No.: PCT/IB05/52463

§ 371 Date: Jan. 24, 2007

(30) Foreign Application Priority Data
Jul. 28, 2004 (EP) 04103644.3

(51) Int. Cl. G06F 15/16; G06F 15/177

(52) U.S. Cl. 709/204; 709/217; 709/220

(57) ABSTRACT

The invention describes a method for contesting at least two interactive systems (2A, 2B) against each other where a message (M) of a first of the interactive systems (2A) is output by the first interactive system in form of an audio-visual and/or tactile expression (AE, VE, TE) and where the audio-visual and/or tactile expression (AE, VE, TE) is detected by a second of the interactive systems (2B) as an input signal (ISA, ISV). The input signal (ISA, ISV) is analyzed by the second interactive system to derive a content of the message (M) and, depending on the content of the message (M) and on given competition rules, a reaction of the second system is triggered. Moreover, the invention describes an interactive system (2A, 2B) usable for taking part in a competition according to this method and an interactive system competition arrangement (1) with at least two of such interactive systems (2A, 2B).

This invention relates in general to a method for contesting at least two interactive systems against each other and to an interactive system competition arrangement with at least two interactive systems to be contested against each other in a competition.

Recent developments in the area of man-machine interfaces have led to widespread use of technical devices or applications which are managed or driven by means of a dialog between an application and the user of the application. Most of these dialog systems are based on the display of visual information and manual interaction on the part of the user. For instance, a user can enter into a dialog or dialog flow with a personal digital assistant in order to plan appointments or read incoming mails. The dialog can be carried out by the dialog system issuing prompts to which the user responds by means of a pen or keyboard input. Furthermore, advanced systems feature speech recognition capabilities in order to receive and process spoken commands, and/or corresponding means for outputting acoustic messages, by using pre-recorded utterances or by speech synthesis. The user can freely interact with such speech dialog systems. Some systems even feature optical detection means, e.g. a camera or system of cameras, with which they can record images of their environment and process or analyze them. Such systems are capable of “observing” their environment, that is to say the environment within reach of the camera. With the use of suitable image processing systems, a user can also communicate with the system through sign language, miming or similar.

All these systems are usually also called “interactive systems”, because the user and the system interact with each other. Such an interactive system can be dedicated to a particular application, for example in the form of a stand-alone interactive device. One example of such a system would be a chess computer with an appropriate dialog interface. However, it is also possible that the interactive system is realized in such a way that it can control several applications, in that, for example, the interactive system is connected to the various applications by means of an appropriate application interface. The applications might be purely software applications, such as a chess engine, a database for managing addresses, books, CDs etc., educational software, or similar. The applications can equally well be actual devices such as a television, video recorder or other consumer electronics device, a household appliance or technical system such as air conditioning, burglar alarm etc., that can be controlled by means of the interactive system. One example of such an interactive system is described in, among others, DE 102 49 060 A1, which is incorporated herewith in its entirety. In this document, an anthropomorphic dialog system is described which communicates with its environment via speech input and speech output as well as via additional sensors, e.g. cameras, and an embodiment of the system which looks “human-like” to some degree, and is able to turn towards the human user by means of one or more motors which are subject to drive control. This anthropomorphic dialog system can be seen as a specific sample of an interactive system designed for the interaction between one or several users and the system and its application.

It is clear that such anthropomorphic interaction systems, which allow a person to control applications and/or devices with the aid of natural (human) dialog, have great advantages, since these systems allow the user interface to suit the usual human modes of communication, unlike current solutions in which the person has had to conform to the limited capabilities of a technical user interface.

The application or applications of the interactive system, as well as the actual user interface part of the interactive system, e.g. the speech recognition, image processing and/or speech output can, in modern systems, be improved by the user. The owner of the individual interactive system can prepare the system e.g. by training it or by buying specific components, software-updates, knowledge-data, dictionaries etc. Each individual system therefore has certain skills, e.g. access to specific knowledge, interaction mechanism or movement capabilities. It can be expected that the owners of interactive systems may spend a lot of effort and money on improving the skills of the interactive systems. After all, competition is part of human nature. Humans compete in sports and in many types of game. Humans even compete in many aspects of daily life. Bearing this in mind, it is clear that the owner of an interactive system who invests a lot of money on improving his interactive system may want to know whether his or her system is the best. It could make interactive systems and the training and/or improving of such systems much more interesting, if there were ways of establishing competitions between the interactive systems. In a competition, the winner is the system which is best with respect to a certain task.

One possible way of comparing interactive systems to each other comprises connecting the systems together by means of, e.g. a cable or wireless connection, so that, during the competition, each system reacts—according to the rules for this contest—to the moves of the opponent system. For example, chess computers often have a mode in which they can play against themselves. To human observers, it can be interesting to observe chess computers playing against each other, since one can learn about strategies and discuss the decisions made by the machines. If two different chess computers are forced to play against each other, the performance and quality of the underlying chess engines can be evaluated.

One disadvantage is that the user interfaces normally used to communicate with the user, e.g. speech input and speech output, or the optical sensors and detection systems, are thereby neither used nor tested.

Therefore, an object of the present invention is to provide a method and a system for contesting at least two interactive systems against each other, where the interactive systems may be contested as a whole, such as they appear to the user.

To this end, the present invention provides a method for contesting at least two interactive systems against each other, where a message of a first of the interactive systems is output by the first interactive system in form of an audio-visual and/or tactile expression, where the audio visual and/or tactile expression is detected by a second of the interactive systems as an input signal and where the input signal is analyzed by the second interactive system to derive a content of the message. Depending on the content of this message, and in accordance with given competition rules, a reaction of the second system is triggered.

The term “audio-visual expression” is to be understood to refer to an expression of the system, which can be optically and/or acoustically registered and interpreted by another suitable system or an audience, e.g. speech gestures etc. Tactile expressions may be any expression which can be felt by the receiving system and is observable by the audience. e.g. a touching by the first interactive system.

The invention is therefore based on the idea that two or more interactive systems of a similar kind can also communicate among themselves. To this end, they avail of a communication mechanism which can be observed from the outside, by using messages in a form which is observable and interpretable by an audience, particularly by the users or proprietors of the systems. A positive important aspect of such type of competition among interactive systems is the opportunity proffered to the users and/or other interactive systems of observing the competition. Thereby, the “behavior” of the interactive system during the competition can be observed by the audience just for fun (entertainment) or in order to learn something from the exchange taking place in the competition (education). In particular, observations made during a competition in progress may be applied to derive a strategy for future competitions. Observing the competition of interactive systems will therefore be at least as interesting as watching sports or quiz shows on television.

An interactive system able to take part in a competition according to the method above must comprise
an output arrangement for outputting a message in form of an audio-visual and/or tactile expression.
an input detection arrangement for detecting an audio-visual and/or tactile expression of another interactive system,
an analyzing arrangement for analyzing the input signal to derive a content of the message,
a source for retrieving given competition rules and further information necessary to take part in the specific competition,
and a control dialog unit for coordinating a dialog flow by generating output messages depending on the content of received messages and on the competition rules.

An interactive system competition arrangement should comprise at least two interactive systems to be contested against each other in the competition, where each of these interactive systems comprises the features mentioned above.

The dependent claims disclose particularly advantageous embodiment features of the invention, whereby the interactive systems and the interactive system competition arrangement could be further developed according to the features of the method claims.

In a preferred embodiment, the interactive system is implemented as a stand-alone device, with a physical aspect such as that of a robot, or, preferably, a human. The interactive system might be realized as a dedicated device as described, for example, in DE 102 49 060 A1, constructed in such a way that a moveable part with schematic facial features can turn to face the user, giving the impression that the device is listening to the user. Such an interactive system might even be constructed in such a fashion that at least the user interface of the system can accompany the user as he moves from room to room. If the individual application is not incorporated in the device itself, an interface between the device and the individual application(s) might be realized by means of cables, or preferably in a wireless manner, such as infra-red, Bluetooth, etc., so that the device remains essentially mobile, and is not restricted to being positioned in the vicinity of the applications which it is used to drive. An application of the interactive system might be a program running as software on a personal computer, a network, or any electronic device controlled by a processor.

User input to the interactive system can be vocal, whereby spoken commands or comments of the user or other interactive systems are recorded by means of the input detection arrangement, for example, a microphone. An advanced input detection arrangement features cameras for sensing movement of the user or other interactive systems, so that the user or another interactive system might communicate with the interactive system by means of gestures, for example by waving his hand or shaking his head. The interactive system interprets the input signal and converts it into a form suitable for understanding by the current application. In a competition according to the invention, this user interface is used for communication with a rival interactive system.

It is clear a verbal utterance is considerably easier to interpret—for the audience as well as an interactive system—than non-verbal utterances. Therefore, it is preferable that the message output by the first interactive system is in the form of a speech utterance, and that the analysis of the input signal by the second interactive system comprises a speech recognition process.

To improve the communication between the opposing systems and to enable an optimal progress of the competition, the output of the interactive systems during the competition might be adjusted depending on the competition-specific application in such a way that it can more easily be interpreted as input by the other interactive systems in the competition.

Preferably, the parameters in a speech output process of the first interactive system and/or parameters of a speech recognition process of the second interactive system are adapted to a current application mode of the interactive systems which are to compete. For example, the speech output might be modified in such a way that the speech recognition modules of the interactive systems can understand the spoken utterance with high accuracy (e.g. by use of long words with regular speed etc.). On the other hand, the vocabulary of the speech recognition modules of the interactive system may be adapted to the current application in order to improve the recognition process.

In a preferred embodiment, the messages are additionally transmitted from the first interactive system to the second interactive system in a machine-readable form. Therefore, an additional, preferably wireless “internal communication channel” for the exchange of information between the competing interactive systems could be used. This supplementary message in machine-readable form is preferably used to confirm the content of the message derived by the second interactive system from the input signal, which is transmitted via the observable, but less secure external communication mode of the audio-visual and/or tactile expression.

For example, the speech output from one interactive system via speech synthesis should normally be recognized by the other interactive system by means of the speech recognizer. At the same time, the system which is producing the speech signal can also transmit the message in machine-readable form, containing the content of the speech signal, via the additional communication channel. Receiving a machine-readable message via the internal communication channel will therefore usually be much more reliable compared to the use of the speech recognition system, which might be affected by the general noise level in the room in which the competition takes place. Incorrect interpretation by the receiving system, due to poor reception of the “external” signal, can thus be avoided.

Preferably, there might be a mechanism to disable communication via the internal channel, since external influence by humans in the form of shouting, etc. during the competition, which influences the outcome of the competition, might actually be encouraged in order to emphasize the fun aspect.

In a preferred embodiment, the message is additionally transmitted from the first interactive system to a monitor unit. This will preferably be done using the internal communication channel. The monitor unit might be a central server connected to the internal communication channel.

The monitor unit is used for monitoring and recording the progress of the competition. This might be useful in order to make sure that there is no cheating going on, and that no tricks are being used to influence the outcome of the competition. Also, the evaluation via a monitoring unit could be used to determine an official result of the competition, which might be required, particularly in scenarios where it is possible to bet on the outcome of a competition between interactive systems.

The monitor unit can also be used to decide whether an interactive system also receives an additional message in machine-readable form via the internal channel. For example, in scenarios where the capabilities of the speech recognition arrangement of the interactive system are being tested, the message sent by the first interactive system can be compared to the content of the message deduced by the receiving interactive system, and it can thus be determined to what degree of accuracy the receiving interactive system has recognized the content of the message. If the message has been inaccurately interpreted, the monitor unit can send the correct result in electronic form to the interactive system concerned, so that the competition can proceed on the basis of the correct interpretation. If desired, an error might be recorded for the interactive system which inaccurately interpreted the message.

The competitions can be held privately or in the form of official contests which might offer prizes for the winning system, or the opportunity to bet on the outcome. The competitions should preferably take place in a physical space where the interactive systems face each other, possibly with an audience, particularly in the case of official competitions.

In order to compare systems at different locations, a preferred embodiment offers the possibility of transmitting a message between a first interactive system and a remote input and/or output device in the vicinity of a second interactive system, for example over a communication channel or network like a telephone network or the internet.

In a first example of such a remote scenario, the message is output from the first interactive system in form of an audio-visual and /or tactile expression, and this expression is detected by a first “remote input/output device” in the vicinity of the first interactive system, for example a PC with a webcam and a microphone, which is connected to the internet. The pictures made by the webcam and/or the acoustic message detected with microphone of the first PC may be then output by a second “remote input/output device” in the vicinity of the second interactive system, for example by another PC. The second interactive system may then detect the audio-visual expression of the first interactive system from the screen and the loudspeaker of the PC and use this as the input signal.

In a second preferred remote scenario, a first interactive system can control, e.g. over the internet or over a telephone network, a remote proxy (third) interactive system or PC as a remote input/output device to compete the first system against the second system.

In all of these remote scenarios, the use of the internal communication channel may be especially important, since the input and output mechanism of the interactive systems might not be completely transferable over a connection such as an internet connection. For example, an interactive system might still be able to control a camera and a microphone in the physical location of the competition via the internet, but the quality of this input is different from what the system would have observed if it had actually been physically present. Therefore, it may be necessary to examine the received message with the aid of a supplementary machine-readable message, also transmitted over the internet or telephone network used for transmitting the audio-visual expression.

Clearly the method is not limited to comparing only two interactive systems with each other. A multitude of interactive systems can compete against each other, depending on the type of competition or the application to be compared.

In particular, it is possible to compare teams of interactive systems with a single interactive system or another team of interactive systems, whereby the output of one interactive system during the competition is the input for all other interactive systems participating in the competition.

In such a scenario, the interactive systems of a team preferably communicate with each other before reacting to a message of a rival interactive system or a rival team.

In more complex scenarios, the human user could also participate in a competition together with the interactive system owned by him or her against another human owner and his or her system. That means that teams of humans and interactive systems compete against each other. The output of one interactive system or human during the competition is not only the input for all other interactive systems but also for all human users participating in the competition. In such competitions the human skills and the skills of the machine could be combined in interesting ways.

To prepare an interactive system for taking part in a competition, the system must be able, as already described, to receive the corresponding competition rules, and basic skill sets or basic information must be made available to the interactive system. In a preferred example, this is done with the aid of a certain competition-specific application module, e.g. in software form. With the aid of such a module, or with appropriate software, an already existing interactive system can be updated or modified to enable it to take part in a competition. This module will often contain the rules of the specific competition together with the basic skill sets for the competition.

Additional skill sets, e.g. for improved knowledge, or for following specific strategies during the competition, could be bought in the form of additional modules, preferably software modules. Potentially, general upgrades for the interactive system, for example more storage memory for an enhanced adaptive learning process, can also have an impact on the performance with respect to certain competitions.

Preferably, the interactive system is capable of learning, i.e. it can learn during a competition or can be trained by its owner to improve its capabilities in preparation for the next competition. Preferably, the interactive system has a competition-specific training mode during which its owner can supply additional knowledge and prepare it for its next competition. In a particularly preferred embodiment of the invention, the interactive system is realized in such a way that it can also be trained by merely observing a competition in which it does not participate

In a preferred embodiment of an interactive system competition arrangement, the arrangement comprises a user interface for inputting competition result prediction data and preferably other betting data for the users or audience into the interactive system competing arrangement, as well as a means for comparing the competition result prediction data with the actual competition result. The system, for example the monitor-unit, can therefore determine the winnings for each bettor.

With such a betting infrastructure for betting on the outcome, especially of public competitions of interactive systems, not only the owners of the interactive system are encouraged to take part by the prospect of winning a prize, but members of the audience are also encouraged to get involved, even if they do not have an interactive system taking part in the competition. This increases the fun-factor and the excitement for the audience. Furthermore, entry fees and betting stakes might cover the cost of prizes and of hosting such contests.

The examples below describe typical application scenarios for such competitions:
Quiz games: an interactive quiz is one of the most natural scenarios for competition among interactive systems. Success is based on the available knowledge as well as the correct understanding and interpretation of the questions. Training means providing additional knowledge. Adaptive learning means that the systems will learn from the responses to previous questions and use this knowledge for generating the correct responses for future questions. The interactive systems can ask each other questions, or humans could formulate and speak the questions. In quiz game scenarios, interactive systems might even compete against humans.
Board games: interactive systems can participate (potentially even together with human users) in all kinds of board games. The rules of such games are more or less straightforward and can be modeled in software. While luck is often an important success factor for board games, winning such games is also frequently related to strategy. Training for board games could, for example, mean defining the optimum strategy, which might potentially even be influenced by anticipating the strategies of the competitors.
Finding something in a room: a popular child's game requires guessing an object, which is in a certain room. During the game, additional information about the object is being revealed by the party which has determined the object and is conducting the game. Interactive systems could play this game as well. In order to identify the objects, they might use pointing as their output modality. Success in this game is closely related to the knowledge about the environment and the available context information about the objects within this environment. Training for this game would therefore require providing information about the environment, in which the competition will take place, and the objects, which are present in this environment.
Identify a song: the task of this game would be to identify a song from a combination of abstract information (e.g. country of origin, year of writing, etc.) and direct information (e.g. parts of the melody). The challenge lies both in the size of the available archive of known songs and in the reasoning process used to identify the song.

Other objects and features of the present invention will become apparent from the following detailed descriptions considered in conjunction with the accompanying drawing. It is to be understood, however, that the drawing is designed solely for the purposes of illustration and not as a definition of the limits of the invention.

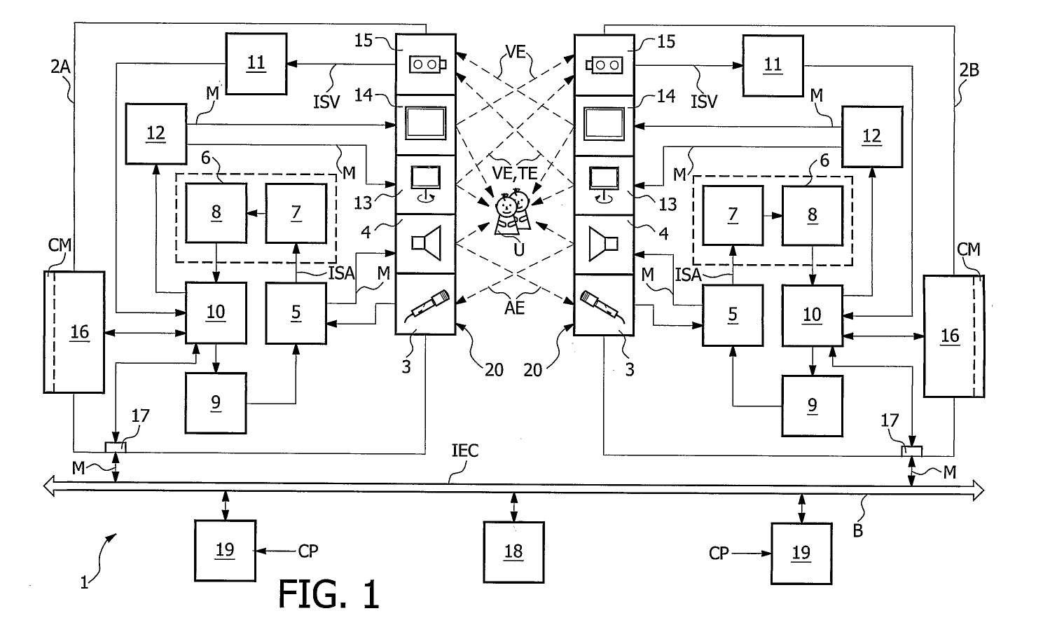

FIG. 1 is a schematic block diagram of interactive system competition arrangement in accordance with an embodiment of the present invention;

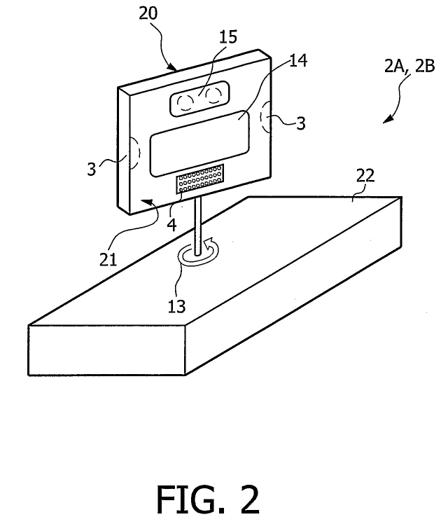

FIG. 2 is a perspective outside view of a preferred embodiment of an interactive system for an interactive system competition arrangement according to FIG. 1;

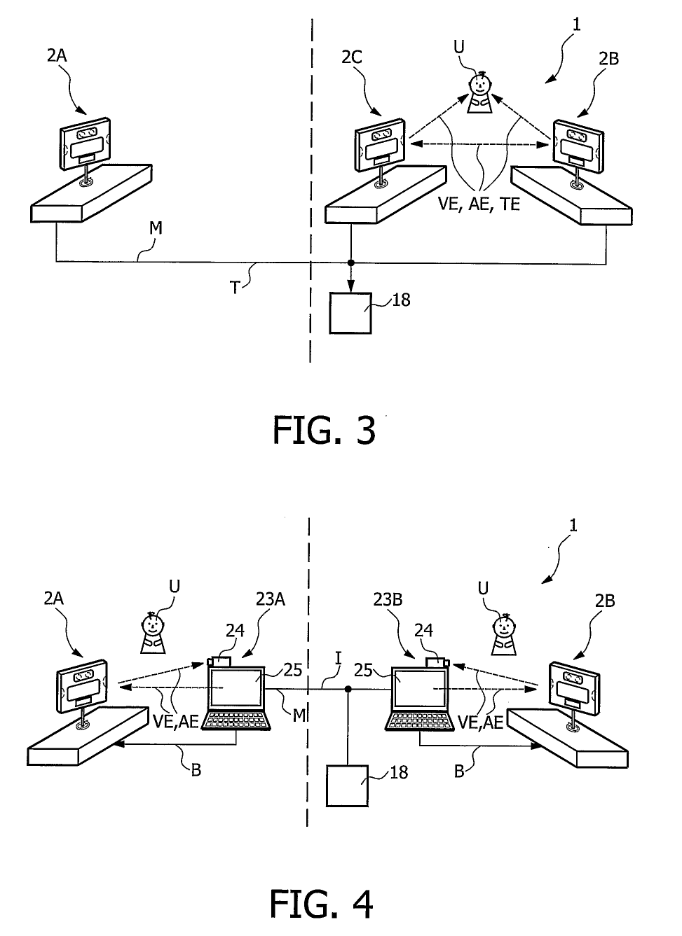

FIG. 3 is a schematic view of interactive system competition arrangement, which uses a remote input/output device according to a first embodiment;

FIG. 4 is a schematic view of interactive system competition arrangement, which uses to remote input/output devices according to a second embodiment.

FIG. 1 shows a relatively simple example of an interactive system competition arrangement comprising only two interactive systems 2A, 2B. In this example, both interactive systems 2A, 2B are constructed identically. Clearly, depending on the type of competition, such an interactive system competition arrangement can comprise considerably more interactive systems, where even groups of interactive systems can compete against each other. This simplified example with only two interactive systems has been chosen for the sake of clarity. Equally, interactive systems that are not identically constructed may compete against each other. A prerequisite is only that the interactive systems are similar and feature comparable applications required for the competition concerned.

Each of the interactive systems 2A, 2B feature a dialog interface 20, which here comprises an acoustic input arrangement 3 such as a microphone 3, an acoustic output arrangement 4 such as one or more loudspeakers 4, an optical input arrangement 15 such as a camera system 15 comprising one or more cameras, a display arrangement 14 and a mechanical output arrangement 13 comprising, for example, one or more motility units.

FIG. 2 shows how such an interactive system can be mechanically constructed. Here, the dialog interface 20 is mounted on a housing 22, and features a clearly recognizable front aspect which can be regarded as the “face” of the dialog interface 20. The dialog interface 20 shown here has a central display 14, a loudspeaker 4, a pair of microphones 3 which can be regarded as the “ears” of the dialog interface 20 or the interactive system, as well as a camera system 15 with a pair of cameras which can serve as the “eyes” of the interactive systems 2A, 2B.

The entire dialog interface 20 can swivel vertically on a first axis, by means of a mechanical output arrangement 13, shown only schematically, and horizontally on a further axis not shown in the diagram, so that the system can “nod” or “shake its head” by appropriately swiveling the dialog interface 20.

Audio expressions which can be registered by the acoustic input arrangement of the other interactive system, such as spoken utterances or similar, can be output via the acoustic output arrangement 4. These audio expressions AE can also be registered and interpreted by a user U present at the competition—here an audience comprising several users U. Equally, visual expressions VE such as gestures can be output via the display arrangement 14 or via mechanical output (in the example of FIG. 2, a mechanical output gesture such as vertical or horizontal swiveling can mean nodding or shaking of the head).

Depending on the capabilities of the mechanical output arrangement, a tactile expression can also be output to another interactive system, for example when this mechanical output arrangement comprises a pointer or an arm or something similar for touching the other interactive system or a tactile sensor such as a haptic or pressure sensor of the other interactive system. Such a tactile sensor of the receiving interactive system is not shown in the simplified representation of FIGS. 1 and 2. Instead, a movement generated with the aid of the mechanical output arrangement 13 is only recorded as a visual expression VE by the optical input arrangement of the other system. Clearly, a tactile expression can also be a visual expression, since every movement of an interactive system or part of an interactive system can generally be visually registered by the other interactive system or by the audience.

The housing 22 of the interactive systems 2A, 2B contains, among others, the components described in FIG. 1. Besides the basic components shown in the figures, the interactive system 2A, 2B can also avail of further components, which, for the sake of clarity, are not shown here.

The acoustic output arrangement 4 and acoustic input arrangement 3 are controlled by an audio control unit 5.

An audio expression AE recorded using the acoustic input arrangement 3 is then forwarded as an acoustic input signal ISA to a speech recognizer 6 of the receiving interactive system. This speech recognizer 6 comprises a speech recognizer kernel unit 7 and the usual following language understanding unit 8. The text identified by the language understanding unit is then passed on to a dialog control unit 10.

Similarly, visual expressions VE are registered by the optical input arrangement 15, in this case the camera system 15, and forwarded initially as a visual input signal ESV, e.g. in the form of images, to an image processing unit 11 which analyses the images for interpretation, and passes the results of its analysis to the dialog control unit 10.

The dialog control unit 10 decides, on the basis of the recognition results from the language understanding unit 8 and/or the image processing unit 11 concerning the content of a message M output by the other interactive system, how the interactive system 2A, 2B concerned is to react to this message by outputting its own message. This depends of course on the actual application 16, which is to be tested together with the other components of the interactive system 2A, 2B during the competition.

The application of the example embodiment shown in FIG. 1 is an application 16 which can be used for other purposes, not only for a competition, for example a dictionary or encyclopedia application. In order to be able to used in a competition, the application 16 includes a competition module CM, here in the form of a software module, which contains the competition rules and the basis information required for taking part in a particular competition.

Such a competition module CM can be implemented in the dialog control unit 10 instead of in the application 16 concerned. However, since the dialog control unit 10 and the application 16 work closely together anyway, it does not usually matter in which of the units the competition module CM is implemented.

The interactive system 2A, 2B can be capable of controlling several applications. To this end, the dialog control unit 10 can be connected to an application interface over which the various external or internal applications can be controlled. In this case, each application can include its own competition module CM, and/or the dialog control unit 10 comprises a competition module which can be used in conjunction with several of the applications.

Depending on the type of reaction, the interactive system 2A, 2B can generate an audio expression AE via the loudspeaker 4, for example a spoken output. To this end, the interactive system 2A, 2B comprises a prompt generator 9 with a speech synthesizer (not shown in the diagram). A message M originating in the dialog control unit 10 is converted here into speech, and then output by the audio control unit 5 via the loudspeaker 4. Alternatively or in addition to this, the dialog control unit 10 can also control an optical/mechanical signal control unit 12, by means of which the message M can be output via the mechanical output arrangement 13 or the display 14. The message is thereby output in the form of a visual expression VE or tactile expression TE. For example, in order to express negation, the dialog interface unit can be swiveled about the vertical axis in a manner similar to shaking one's head, or appropriate images can be displayed on the screen.

The interactive system 2A, 2B shown in the example embodiment of FIG. 1 both comprise a network interface 17, by means of which they are connected to a bus B. This bus B serves as an internal electronic channel IEC, over which messages M can also be exchanged between the interactive systems 2A, 2B in electronic form.

Furthermore, a monitor unit 18 and user interfaces 19 are also connected to this bus B. A message M is transmitted to the other interactive system 2A, 2B, so that it can compare the actual content of the message M in electronic form with the interpreted content of the message M recorded by the dialog interface 20 and the speech recognizer unit 6 or the image processing unit 11, in order to eliminate errors. Whether such error elimination is allowed, or whether it is carried out when allowed, is determined, for example, by the monitor unit 18.

The monitor unit 18 monitors the progress of the competition. The users can enter competition result prediction data CP and other betting data such as wagers, via the user interfaces 19. This information is also transmitted to the monitor unit 18, which then compares the competition result prediction data CP with a later competition result to determine the winner and calculate the winnings. In the case of compact realizations, the user interfaces 19 can also be integrated in the monitor unit 18.

FIGS. 3 and 4 show variations of how a comparison between two interactive systems is possible even when these are located apart from each other. Spatial separation is indicated by the vertical dashed line.

In the first case, a first interactive system 2A, stationed in one location, is to compete with a second interactive system 2B in a remote location by controlling, in a master/slave mode, a comparable (third) interactive system 2C, located near the second interactive system 2B. The third interactive system 2C serves as a proxy interactive system for the first interactive system 2A, i.e. as a remote input output device 2C. Control is achieved by transmitting the messages M of the first interactive system 2A via an electronic channel, in this case a telephone connection T, to the proxy interactive system 2C. The proxy interactive system 2C then behaves as though it were the first interactive system 2A, and outputs the messages M in the form of audio-visual and/or tactile expressions AE, VE, TE, which can be registered by an audience in the vicinity of the second interactive system 2B or by the second interactive system 2B itself. Similarly, the proxy interactive system 2C registers the audio-visual and/or tactile expressions AE, VE, TE, of the opponent interactive system 2B and transmits these as input signals, for example over the telephone connection T, back to the remote interactive system 2A. Preferably, the input signals ISA, ISV registered by the acoustical input arrangement 3 and the optical input arrangement 15 are transferred directly to the remote interactive system 2A, which itself can then analyze and interpret the signals with its own speech recognizer 6 and image processor 11.

At the same time, the competing active systems 2A, 2B can send each other messages in electronic form via telephone cable, for example for the purposes of cross checking, whereby a monitor unit 18, and possibly also user interfaces (not shown in the diagram), can also be connected up to the competing interactive systems 2A, 2B.

FIG. 4 shows a somewhat different version for a competition between two interactive systems 2A, 2B found in different locations. Here, each interactive system 2A, 2B makes use of a PC 23A, 23B, each of which features a webcam 24 and a display 25. Each PC 23A, 23B also has a microphone and loudspeaker (not shown in the diagram). The PCs are connected via the internet I to which is connected a monitor unit 18, for example in the form of a central server, assigned perhaps to the organizer and/or referee of the competition. The interactive systems 2A, 2B are each connected by means of a bus B with their respective PC 23A, 23B. Audio-visual and tactile expressions AE, OE of an interactive system 2A, 2B are recorded by its allocated webcam 24 and microphone and forwarded to the PC of the other interactive system 2A, 2B via the internet, to be rendered there by means of the display 25 and loudspeaker. In addition, the messages can also be transmitted in electronic form via the bus connection B and the internet I. All data can be recorded by the monitor unit 18, which can also control the competition and can prevent the messages M from being transmitted directly in machine-readable form to the receiving system.

Although the present invention has been disclosed in the form of preferred embodiments and variations thereon, those skilled in the art will understand that numerous additional modifications and variations could be made thereto without departing from the scope of the invention.

For the sake of clarity, throughout this application, it is to be understood that the use of “a” or “an” does not exclude a plurality, and “comprising” does not exclude other steps or elements. The use of “unit” or “module” does not limit realization to a single unit or module.

1. A method for contesting at least two interactive systems (2A, 2B) against each other
where a message (M) of a first of the interactive systems (2A) is output by the first interactive system in form of an audio-visual and/or tactile expression (AE, VE, TE),
where the audio-visual and/or tactile expression (AE, VE, TE) is detected by a second of the interactive systems (2B) as an input signal (ISA, ISV),
where the input signal (ISA, ISV) is analyzed by the second interactive system to derive a content of the message (M) and
where, depending on the content of the message (M) and on given competition rules, a reaction of the second system is triggered.

2. A method according claim 1, where the message is output by the first interactive system (2A) in form of a speech utterance (AE) and the analysis of the input signal (ISA) by the second interactive system (2B) comprises a speech recognition process.

3. A method according to claim 1, where parameters in a speech outputting process of the first interactive system (2A) and/or parameters of a speech recognition process of the second interactive system (2B) are adapted to a current application mode of the interactive systems (2A, 2B) which are to compete.

4. A method according to claim 1, where the message (M) is additionally transmitted from the first interactive system (2A) to the second interactive system (2B) in a machine-readable form.

5. A method according to claim 4, where the message (M) in machine-readable form is used to confirm the content of the message derived from the input signal (ISA, ISV) by the second interactive system (2B).

6. A method according to claim 1, where the message (M) is additionally transmitted from the first interactive system (2A) to a monitor unit (18).

7. A method according to claim 1, where the message (M) is transmitted between a first interactive system (2A) and a remote input and/or output device (2C, 23B) in the vicinity of a second interactive device (2B).

8. A method according to claim 1, where a team of interactive systems competes with a single interactive system or with another team of interactive systems.

9. A method according to claim 8, where at least two interactive systems of a team communicate with each other before reacting to a message of an rival interactive system or rival team.

10. An interactive system (2A, 2B) usable for taking part in a competition according to claim 1, comprising
an output arrangement (4, 13, 14) for outputting a message (M) in form of an audio-visual and/or tactile expression (AE, VE, TE),
an input arrangement (3, 15) for detecting an audio-visual and/or tactile expression of another interactive system (2B, 2A),
an analyzing arrangement (6, 11) for analyzing the input signal (ISA, ISV) to derive a content of the message (M),
a source (CM) for retrieving given competition rules and further information necessary to take part in the competition
a control dialog unit (10) for coordinating a dialog flow by generating messages (M) to be output, depending on the content of received messages (M) and on the competition rules.

11. An interactive system competition arrangement (1) with at least two interactive systems (2A, 2B) according to claim 10.

12. An interactive system competition arrangement according to claim 11, comprising a monitor unit (18) for monitoring the progress of the competition.

13. An interactive system competition arrangement according to claim 11, comprising a user interface (19) for inputting competition result prediction data (CP) of users to the interactive system competition arrangement (1) and means for comparing the competition result prediction data (CP) with a competition result.

14. Competition module (CM) for implementation in an interactive system (2A, 2B) according to claim 10, which competition module (CM) contains competition rules and/or further information to enable the system (2A, 2B) to take part in a competition.
